(19) United States
(12) Patent Application Publication
(10) Pub. No.: US 2024/0192013 A1
(43) Pub. Date: Jun. 13, 2024

(54) DISTRIBUTED COMPUTING PARKING ASSIST SYSTEM

(71) Applicant: Got Spot?, Glenarden, MD (US)

(72) Inventor: Philip Dexter McNair, SR., Glenarden, MD (US)

(73) Assignee: Got Spot?, Glenarden, MD (US)

(21) Appl. No.: 18/062,746

(22) Filed: Dec. 7, 2022

(51) Int. Cl. G01C 21/36

(52) U.S. Cl. CPC G01C 21/3685

(57) ABSTRACT

A parking assist system is described. The system may include a transceiver configured to receive a travel route destination location and a vehicle real-time geolocation. The system may further include a memory configured to store parking information associated with a geographical area in proximity to the destination location. The system may additionally include a processor configured to transmit a first command signal to a first user interface to display a navigation map based on the travel route destination location and a vehicle real-time geolocation. The processor may determine whether a distance between the vehicle real-time geolocation and the travel route destination location is less than a predefined threshold. When the distance is less than the predefined threshold, the processor may transmit a second command signal to the first user interface to switch display from the navigation map to a parking location map to display the parking information.

### TECHNICAL FIELD

The present disclosure relates to a distributed computing parking assist system, and more particularly, to a parking assist system that enables a user to locate and reserve a parking spot at a destination location.

### BACKGROUND

Finding available parking spots is a challenge that many users face on a daily basis, especially in crowded metropolitan areas. Typically, users spend considerable time and resources searching for an available parking spot. For example, a user may drive in proximity of a metropolitan block for a substantial time duration searching for an available parking spot. This may result in road congestion, wastage of vehicle fuel and an increase in air pollution.

There exist conventional systems that provide information of parking spots in a geographical area to users. For example, there exist parking spot prediction applications (apps) that “predict” parking spot availability based on historical usage trends. Generally, the information provided by such applications is not accurate and up-to-date, and hence may have limited utility for users.

Thus, there exists a need for a parking assist system that provides accurate parking spot information to users and enables the users to conveniently identify available parking spots.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts a block diagram of an example parking assist system in accordance with the present disclosure.

FIG. 3 depicts a first example snapshot of a user interface in accordance with the present disclosure.

FIG. 4 depicts a second example snapshot of a user interface in accordance with the present disclosure.

FIG. 5 depicts a flow diagram of an example parking assist method in accordance with the present disclosure.

### DETAILED DESCRIPTION

### Overview

The present disclosure describes a parking assist system that provides navigation and parking assistance to a vehicle user. The system may receive a destination location associated with a travel route that the user may undertake and a real-time vehicle geolocation. The system may determine a distance between the real-time vehicle geolocation and the destination location to estimate whether the vehicle is in proximity to the destination location. The system may cause a user device associated with the user or a vehicle Human Machine Interface (HMI) to display a navigation map, including turn-by-turn navigation instructions, when the vehicle is away from the destination location. The navigation map may assist the user to reach to the destination location. Further, the system may cause the user device/vehicle HMI to switch display from the navigation map to a parking location map, when the vehicle is in proximity to the destination location. The parking location map may include locations of potentially available parking spots in proximity to the destination location, and expected vacancy time for each potentially available parking spot. The user may select a potentially available parking spot to “hold” or reserve the parking spot, based on expected vacancy time. The system may additionally assist the user navigate the vehicle to the available parking spot.

In some aspects, the system may store locations of one or more parking spots in a geographical area in proximity to the destination location, and the corresponding occupancy status of each parking spot. The occupancy status for a parking spot may include, for example, information associated with whether the parking spot is currently occupied or vacant, and expected vacancy time if the parking spot is occupied. The expected vacancy time may be a time in a future when a vehicle currently parked at the parking spot may be expected to leave. In some aspects, a user associated with the vehicle currently parked at the parking spot may transmit the expected vacancy time to the system.

In additional aspects, the system may store advertisement information associated with one or more service providers or events that may be located in proximity to the destination location. The system may cause the user device or the vehicle HMI to display the advertisement information when the system determines that the vehicle is parked at the parking spot.

The present disclosure discloses a parking assist system that provides navigation and parking assistance to the user in a single system/application (“app”). The user is not required to install separate systems or apps on the user device or the vehicle HMI for navigation and parking assistance. The system automatically switches display from the navigation map to the parking location availability map when the vehicle reaches the destination location, thus enhancing user convenience. Further, since the system automatically switches the display, the user may focus on driving the vehicle rather than manually changing the systems/apps on the user device, thus reducing probability of any adverse vehicle incident. Furthermore, since the system receives expected leave times for parking spots from users themselves, the system provides accurate and up-to-date parking occupancy information, which enhances user experience to locate the available parking spot. In addition, the system enables the user to reserve a potentially available parking spot.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

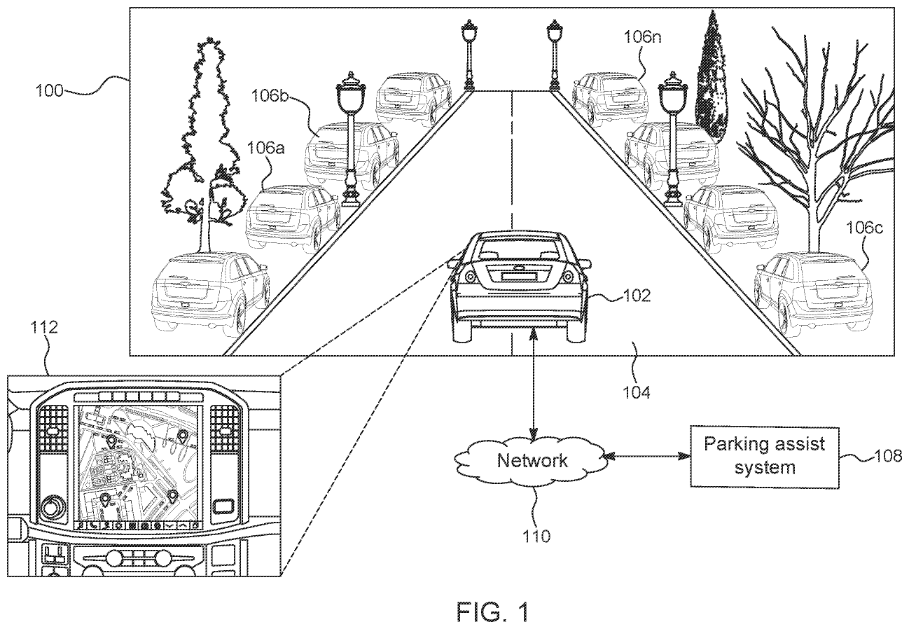

FIG. 1 depicts an example environment 100 in which techniques and structures for providing the systems and methods disclosed herein may be implemented. The environment 100 may include a first vehicle 102 (or a vehicle 102) that may be located or travelling on a road network 104. The road network 104 may be associated with a metropolitan area that may include one or more public and/or private parking spots.

The vehicle 102 may take the form of any passenger or commercial vehicle such as, for example, an off-road vehicle, a car, a crossover vehicle, a van, a minivan, a bus, a truck, etc. Further, the vehicle 102 may include any powertrain such as, for example, a gasoline engine, one or more electrically-actuated motor(s), a hybrid system, etc. Furthermore, the vehicle 102 may be a manually driven vehicle and/or be configured and/or programmed to operate in a fully autonomous (e.g., driverless) mode or in one or more partial autonomy modes which may include driver assist technologies.

In some aspects, a vehicle user (not shown) driving the vehicle 102 may require a parking spot from the one or more parking spots on the road network 104 to park the vehicle 102. In an exemplary aspect shown in FIG. 1, the one or more parking spots may be occupied by one or more second vehicles 106a, 106b, 106c, 106n (or a second vehicle 106).

The vehicle 102 and/or a user device (not shown) associated with the vehicle user may be communicatively coupled to a parking assist system 108 via a network 110. The network 110 may be, for example, a communication infrastructure in which the connected devices discussed in various embodiments of this disclosure may communicate. The network 110 may be and/or include the Internet, a private network, public network or other configuration that operates using any one or more known communication protocols such as, for example, transmission control protocol/Internet protocol (TCP/IP), Bluetooth®, BLE®, Wi-Fi based on the Institute of Electrical and Electronics Engineers (IEEE) standard 802.11, UWB, and cellular technologies such as Time Division Multiple Access (TDMA), Code Division Multiple Access (CDMA), High Speed Packet Access (HSPDA), Long-Term Evolution (LTE), Global System for Mobile Communications (GSM), and Fifth Generation (5G), to name a few examples.

The parking assist system 108 may assist the vehicle 102 to navigate from a source location to a destination location along a vehicle travel route. For example, the vehicle user may input the source location and the destination location of a travel route on the user device or a vehicle 102 Human Machine Interface (HMI, not shown). In some aspects, the vehicle user may input a destination location that may be in proximity to the road network 104. The user device or the vehicle 102 may transmit the source location and the destination location to the system 108 via the network 110. In further aspect, the user device or the vehicle 102 may automatically obtain real-time vehicle 102 geolocation from a vehicle 202 Telematics Control Unit (TCU, not shown) or the user device (when the user device is inside the vehicle 102) as the source location, and may transmit the source location to the system 108.

Responsive to receiving the source and destination locations, the system 108 may assist in navigating the vehicle 102 from the source location to the destination location. In an exemplary aspect, the system 108 may transmit a first command signal, including a navigation map, to display the navigation map on the user device or the vehicle 102 HMI, and assist in navigating the vehicle 102 to the destination location. For example, the user device or the vehicle 102 HMI may display the navigation map (on a user interface associated with the user device or the vehicle 102 HMI), and the vehicle user may follow the navigation instructions included in the navigation map to travel from the source location to the destination location.

In further aspects, the system 108 may determine whether the vehicle 102 is in proximity to (e.g., within 100 or 200 feet of) the destination location based on the real-time vehicle 102 geolocation. Responsive to determining that the vehicle 102 is in proximity to the destination location, the system 108 may send a second command signal, including a parking location map, to the user device or the vehicle 102 HMI and automatically switch the user interface from displaying the navigation map to the parking location map. The parking location map may include locations of “available” parking spots or “potentially available” parking spots from the one or more parking spots on the road network 104. The “potentially available” parking spots may be the parking spots that may become vacant (and hence available for parking) within a predefined future time duration, e.g., within 15 minutes of the vehicle 102 arriving at the destination location. In some aspects, the parking location map may include location icons for the available parking spots or potentially available parking spots (as shown in view 112) and expected availability or vacancy time (not shown) of each potentially available parking spot.

In some aspects, the system 108 may receive an expected leave time or parking spot vacancy time from each second vehicle 106 (or a set of second vehicles 106) that may be parked on the parking spots. The system 108 may store the expected leave times in a system memory (not shown). The expected leave time may indicate a time in the future when the corresponding second vehicle 106 is expected to vacate the parking spot that the second vehicle 106 may be occupying. Responsive to determining that the vehicle 102 is in proximity to the destination location, the system 108 may determine the parking spots that may be getting vacated within a predefined time duration (e.g., 15 minutes) in the future, and display those parking spots as “potentially available” parking spots that the vehicle user may use to park the vehicle 102. The system 108 may also display the expected leave times for each parking spot, so that the vehicle user may view the location of each available parking spot as well as the expected vacancy time.

Responsive to viewing the location and the expected vacancy time for each parking spot, the vehicle user may select a parking spot for reservation. For example, the vehicle user may click on a parking spot icon that may be displayed on the user interface of the user device or the vehicle 102 HMI. Responsive to the vehicle user clicking the icon, the user device or the vehicle 102 HMI may send a request to the system 108 to “hold” the parking spot for the vehicle user. Stated another way, the vehicle user may send a request, via the system 108, to a second user associated with the second vehicle 106 that may be occupying the parking spot to “hold” the parking spot till the vehicle 102 arrives at the parking spot.

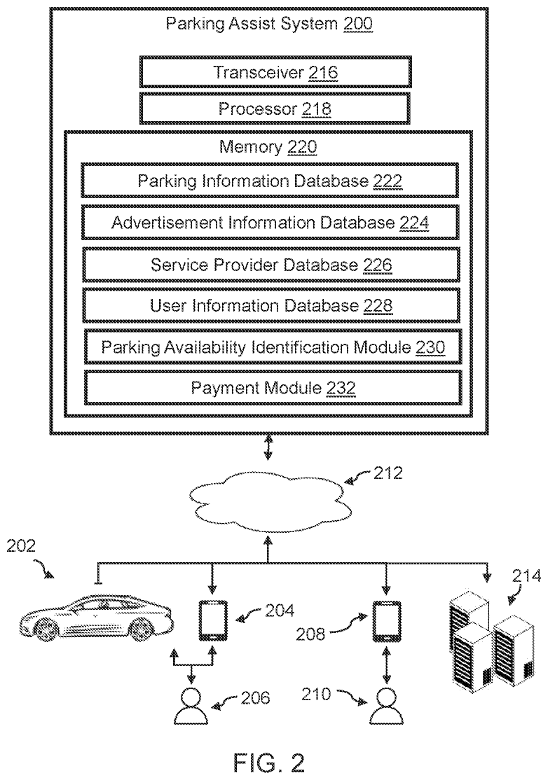

Responding to receiving a parking spot hold request, the system 108 may send the parking spot hold request to a second user device associated with the second user or a second vehicle 106 HMI. The second user may accept the parking spot hold request. Responsive to the second user accepting the request, the system 108 may reserve the parking spot for the vehicle user. The process of reserving the parking spot may be understood in detail in conjunction with FIG. 2.

In additional aspects, the system 108 may assist the vehicle 102 to navigate to the parking spot when the second user accepts the parking spot hold request. In further aspects, the parking assist system 108 may be configured to display location-specific advertisement on the user device or the vehicle 102 HMI when the vehicle 102 is in proximity to the destination location or when the vehicle 102 is parked at the parking spot. Furthermore, the vehicle user may request for valet service providers associated with the system 108 when the vehicle 102 is in proximity to the destination location.

These and other aspects of the present disclosure are described in detail in conjunction with FIG. 2.

A person ordinarily skilled in the art may appreciate that since the system 108 automatically switches the navigation map to the parking location availability map when the vehicle 102 is in destination location proximity, the vehicle user is not required to switch systems (or application/“apps”) to view available parking spots while the vehicle user may be driving or nearing the destination location. The present disclosure provides a single system (or a single app) that may enable the vehicle user to navigate to the destination location and view available parking spot locations. Furthermore, since the system 108 displays available/potentially available parking spot locations and expected vacancy times on a single parking location map, the vehicle user may conveniently select a parking location that suits user's requirements and reserve the parking spot.

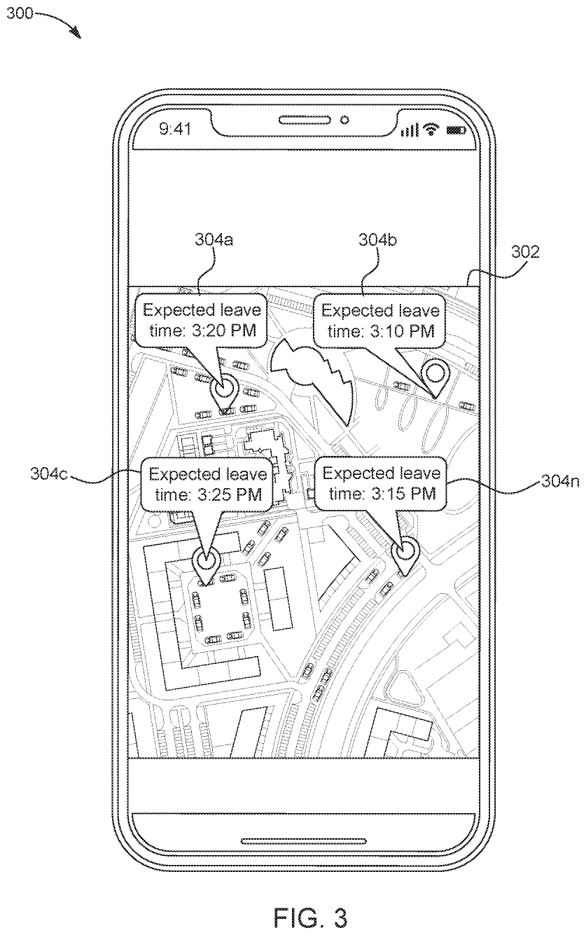

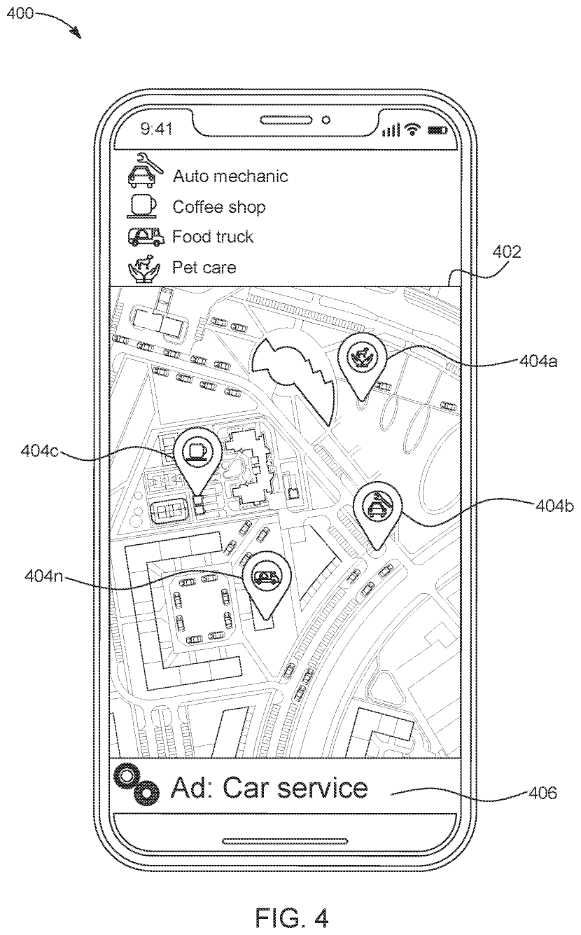

FIG. 2 depicts a block diagram of an example parking assist system 200 in accordance with the present disclosure. While describing FIG. 2, references may be made to FIGS. 3 and 4.

The system 200 may be same as the parking assist system 108, and may be communicatively connected with a vehicle 202, a first user device 204 (associated with a first user 206) and a second user device 208 (associated with a second user 210) via a network 212. The vehicle 202 may be same as the vehicle 102 and the network 212 may be same as the network 110. The first user device 204 and the second user device 208 may be, for example, mobile phones, laptops, computers, tablets, or similar devices with communication capabilities. In some aspects, the second user 210 may be associated with a second vehicle (e.g., the vehicle 106, not shown in FIG. 2) that may be parked at a parking spot on the road network 104.

The system 200 may be further communicatively coupled to one or more servers 214 (or a server 214) via the network 212. The server 214 may be part of a cloud-based computing infrastructure, and may be associated with and/or include a Telematics Service Delivery Network (SDN) that provides digital data services to the vehicles 202, 106 and other vehicles (not shown in FIG. 2). In an exemplary aspect, the server 214 may be associated with a navigation service provider and may provide navigation services to the vehicles 202, 106 and the first and second user devices 204, 208, via the system 200.

In some aspects, the system 200 may be an application (“app”) that may be hosted on one or more distributed computing devices and/or a server (e.g., the server 214). Further, although FIG. 2 depicts that the system 200 is communicatively connected with the vehicle 202, the first and second user devices 204, 208, a person ordinarily skilled in the art may appreciate that the system 200 may be communicatively coupled to a plurality of additional vehicles and user devices simultaneously.

The system 200 may include one or more components or units including, but not limited to, a transceiver 216, a processor 218, and a memory 220. The transceiver 216 may be configured to communicate with external devices via the network 212. For example, the transceiver 216 may receive data or information, including real-time geolocation, user information, vehicle telematics data, and/or the like, from the vehicles 202, 106 and the first and second user devices 204, 208, via the network 212. Further, the transceiver 216 may receive navigation information, e.g., navigation maps, navigation instructions, etc., from the server 214. In a similar manner, the transceiver 216 may transmit data or information, including navigation maps, parking location availability information or maps, advertisement information, and/or the like, to the vehicles 202, 106 and the first and second user devices 204, 208.

In some aspects, the memory 220 may store programs in code and/or store data for performing various system 200 operations in accordance with the present disclosure. Specifically, the processor 218 may be configured and/or programmed to execute computer-executable instructions stored in the memory 220 for performing various system 200 functions in accordance with the disclosure. Consequently, the memory 220 may be used for storing code and/or data code and/or data for performing operations in accordance with the present disclosure.

In one or more aspects, the processor 218 may be disposed in communication with one or more memory devices (e.g., the memory 220 and/or one or more external databases (not shown in FIG. 2)). The memory 220 can include any one or a combination of volatile memory elements (e.g., dynamic random-access memory (DRAM), synchronous dynamic random access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM), etc.).

The memory 220 may be one example of a non-transitory computer-readable medium and may be used to store programs in code and/or to store data for performing various operations in accordance with the disclosure. The instructions in the memory 220 can include one or more separate programs, each of which can include an ordered listing of computer-executable instructions for implementing logical functions.

In some aspects, the memory 220 may include a plurality of modules and databases including, but not limited to, a parking information database 222, an advertisement information database 224, a service provider database 226, a user information database 228, a parking availability identification module 230 and a payment module 232. The parking availability identification module 230 and the payment module 234, as described herein, may be stored in the form of computer-executable instructions, and the processor 218 may be configured and/or programmed to execute the stored computer-executable instructions for performing system 200 functions in accordance with the present disclosure. The functions of the plurality of databases and modules included in the memory 220 are described later in the description below.

In operation, the transceiver 216 may receive user information associated with the first user 206 and the second user 210 when the respective users access the system 200 for the first time. For example, the transceiver 216 may receive the user information from the first and second user devices 204, 208 when the first and second users 206, 210 register on the system 200, respectively. The user information may include, but is not limited to, user name, user address, user contact details, vehicle information associated with the user, bank account details, credit card information, and/or the like. The vehicle information may include, for example, vehicle model, manufacture year, vehicle color, and/or the like.

Responsive to receiving the user information, the transceiver 216 may send the user information to the user information database 228 for storage purpose. The first and second users 206, 210 may access the system 200 for receiving navigation and parking assistance, when the first and second users 206, 210 are registered with the system 200 (i.e., when the respective user information is stored in the user information database 228).

In some aspects, the first user 206 may provide travel route information (e.g., source and destination locations) to the system 200 for receiving navigation and parking assistance. The travel route information may be associated with a travel route that the first user 206 may undertake. Specifically, the first user 206 may input the source and destination locations associated with the travel route on the first user device 204 or vehicle 202 HMI (not shown), and the first user device 204 or the vehicle 202 HMI may transmit the source and destination location information to the transceiver 216, via the network 212. Stated another way, the transceiver 216 may be configured to receive the source and destination locations associated with first user 206 travel route from the first user device 204 or the vehicle 202 HMI. In an exemplary aspect, the destination location may be in proximity to the road network 104.

Responsive to receiving the source and destination locations, the transceiver 216 may send the received locations to the user information database 228 for storage purpose.

Although the description above describes an aspect where the first user 206 provides the source and destination locations to the system 200, in other aspects, the system 200 may automatically obtain source and destination locations. For example, the system 200 may obtain the source location from the vehicle 202 TCU, and destination location based on vehicle 202 historical travel pattern. For example, a vehicle 202 memory (not shown) may store the vehicle 202 historical travel pattern, and the vehicle 202 TCU (or any other vehicle 202 unit) may transmit the vehicle 202 historical travel pattern to the transceiver 216, via the network 212. Responsive to receiving the vehicle 202 historical travel pattern from the vehicle 202 TCU, the transceiver 216 may send the vehicle 202 historical travel pattern to the processor 218. The processor 218 may determine the source and destination locations based on the vehicle 202 historical travel pattern. In this case, the processor 218 may send the determined source and destination locations to the user information database 228 for storage purpose.

The transceiver 216 may further receive vehicle 202 real-time geolocation from the vehicle 202 TCU or the first user device 204 (e.g., when the first user 206 is inside the vehicle 202 and accesses the system 200 via the first user device 204). Responsive to receiving the vehicle 202 real-time geolocation, the transceiver 216 may send the vehicle 202 real-time geolocation to the processor 218.

Responsive to receiving the vehicle 202 real-time geolocation, the processor 218 may fetch the destination location from the user information database 228, and determine a distance between the destination location and the vehicle 202 real-time geolocation. When the processor 218 determines that the distance is greater than a threshold (e.g., 100 or 200 feet), the processor 218 may fetch a navigation map from the server 214 and transmit the navigation map to the first user device 204 or the vehicle 202 HMI. The navigation map may assist the first user 206 navigate the vehicle 202 from the vehicle 202 real-time geolocation to the destination location. The navigation map may include turn-by-turn navigation instructions that may assist the first user 206 to reach to the destination location.

In particular, responsive to fetching the navigation map from the server 214, the processor 218 may transmit a first command signal, via the transceiver 216, to the first user device 204 and/or the vehicle 202 HMI. In some aspects, the first command signal may include instructions to cause a first user device user interface (UI) or the vehicle 202 HMI to display the navigation map. The first command signal may further include the navigation map that the processor 218 fetches from the server 214.

Responsive to receiving the first command signal, the first user device UI or the vehicle 202 HMI may display the navigation map. The first user 206 may follow the turn-by-turn navigation instructions included in the navigation map and drive the vehicle 202 to the destination location. If the vehicle 202 is an autonomous vehicle, a vehicle 202 driver assistance controller (not shown) may use the navigation instructions and navigate the vehicle 202. In additional aspects, the first command signal may cause a first user device speaker or vehicle 202 speaker to audibly output the turn-by-turn navigation instructions to assist the first user 206 in navigating the vehicle 202.

In some aspects, the transceiver 216 may receive the vehicle 202 real-time geolocation at a predefined frequency from the vehicle 202 TCU or the first user device 204. For example, the transceiver 216 may receive the vehicle 202 real-time geolocation every 100 millisecond. Further, the processor 218 may determine the distance between the vehicle 202 real-time geolocation and the destination location at the predefined frequency.

When the processor 218 determines that the distance is less than the threshold (e.g., 100 or 200 feet), the processor 218 may obtain parking information associated with a geographical area in proximity to the destination location from the parking information database 222. Stated another way, the processor 218 may obtain the parking information from the parking information database 222 when the vehicle 202 is in proximity to the destination location or when the vehicle 202 arrives at the destination location. The parking information may include parking spot locations in a geographical location in proximity to the destination location and occupancy status of each parking spot. The occupancy status may include an indication whether the parking spot is currently vacant or occupied. If the parking spot is currently occupied, the occupancy status may include an expected vacancy time associated with the parking spot. The parking information may be understood as follows.

In some aspects, the second user 210, who may have parked the vehicle 106 at a parking spot (e.g., a parking spot “A”, not shown) on the road network 104, may transmit expected parking spot leave time or vacancy time to the system 200 via the second user device 208. For example, when the second user 210 parks the vehicle 106 at the parking spot “A”, the processor 218 may send a request (via the transceiver 216) to the second user device 208 to provide an expected leave time at which the second user 210 expects to vacate the parking spot “A”. Responsive to receiving the request, the second user 210 may input the expected leave time on the second user device 208, and the transceiver 216 may receive the expected leave time from the second user device 208 via the network 212. The transceiver 216 may send the received expected leave time to the parking information database 222 for storage purpose. In this manner, the parking information database 222 may store information indicating that the vehicle 106 (associated with the second user 210) is parked at the parking spot “A”, and the corresponding expected parking spot “A” vacancy time.

In a similar manner, the parking information database 222 may store information associated with one or more parking spots on the road network 104 (i.e., on a geographical area that may be in proximity to the destination location). As described above, the parking information may further indicate the occupancy status of each parking spot (e.g., whether a parking spot is occupied or vacant), and corresponding expected parking spot vacancy time (when the parking spot is occupied).

When the processor 218 determines that the vehicle 202 is in proximity to the destination location, the processor 218 may fetch the parking information from the parking information database 222, and execute instructions stored in the parking availability identification module 230 to determine one or more “available” or “potentially available” parking spots for the first user 206. The “potentially available” parking spots may be those parking spots that may get vacated within a predefined time duration in the future. For example, the processor 218 may determine expected parking spot vacancy times for all parking spots included in the parking availability information, and may select those parking spots as the “potentially available” parking spots for the first user 206 that may get vacated in the next 15 minutes.

Responsive to determining the “available” or “potentially available” parking spots, the processor 218 may generate a parking location map (or parking location availability map), which may include locations of the “available” or “potentially available” parking spots included or superimposed on a geographical map of the road network 104. In some aspects, the parking location map may further include expected leave time for each “potentially available” parking spot.

The processor 218 may transmit a second command signal, via the transceiver 216, to the first user device 204 and/or the vehicle 202 HMI in response to generating the parking location map. In some aspects, the second command signal may include instructions to cause the first user device UI or the vehicle 202 HMI to automatically switch display from the navigation map to the parking location map. The second command signal may further include the parking location map or the parking location availability information, so that the first user device 204 and/or the vehicle 202 HMI may display the parking location map.

Responsive to receiving the second command signal, the first user device 204 and/or the vehicle 202 HMI may automatically switch display from the navigation map to the parking location map. Stated another way, when the vehicle 202 arrives at the destination location, the first user device 204 and/or the vehicle 202 HMI may automatically switch display from the navigation map to the parking location map, and the first user 206 may not be required to input any additional requests or switch systems or applications (apps). A person ordinarily skilled in the art may appreciate that automatic switching of display enhances user convenience and operational efficiency of the first user device 204 and/or the vehicle 202 HMI, as the user is not required to install different systems/apps for navigation and parking assistance.

An example of a parking location map is depicted in FIG. 3. Specifically, FIG. 3 depicts a first example snapshot 300 of a user interface 302 in accordance with the present disclosure. The user interface 302 may be a first user device 204 display screen. A person ordinarily skilled in the art may appreciate that the same user interface 302 may also be a vehicle 202 display screen or a display screen of a vehicle 202 infotainment system.

As shown in the snapshot 300, the user interface 302 may display locations of one or more potentially available parking spots 304a, 304b, 304c, 304n (or potentially available parking spots 304), and their corresponding expected vacancy times (when the parking spots are occupied). In additional aspects (not shown), the user interface 302 may display vehicle models and/or colors of vehicles currently parked at the potentially available parking spots 304.

The first user 206 may view the potentially available parking spots 304, and may select a parking spot to park the vehicle 202 based on parking spot location and the expected vacancy time. For example, the first user 206 may click on parking spot 304a icon on the user interface 302 to select the parking spot 304a. Responsive to the first user 206 selecting the parking spot 304a, the first user device 204 may send the selection to the transceiver 216, via the network 212. The transceiver 216 may then send the selection to the processor 218, which may identify the user (e.g., the second user 210) and the corresponding vehicle (e.g., the vehicle 106) that may be currently parked at the parking spot 304a. In some aspects, the processor 218 may identify the second user 210 and the vehicle 106 that may be parked at the parking spot 304a by using information stored in the parking information database 222 and the user information database 228.

Responsive to determining that the vehicle 106 is parked at the parking spot 304a, the processor 218 may transmit, via the transceiver 216, a parking “hold” request to the second user device 208. The parking hold request may include request for the second user 210 to “hold” the parking spot 304a till the vehicle 202 arrives at the parking spot 304a. Stated another way, the parking hold request may be a request for the second user 210 not to vacate the parking spot 304a till the vehicle 202 arrives at the parking spot 304a. In some aspects, the parking hold request may further include expected arrival time of the vehicle 202 at the parking spot 304a, the vehicle 202 real-time geolocation (so that the second user 210 may track vehicle 202 location), vehicle 202 model, color information, and/or the like. Responsive to receiving the parking hold request on the second user device 208, the second user 210 may accept or reject the parking hold request.

In a scenario when the second user 210 rejects the parking hold request, the processor 218 may transmit, via the transceiver 216, a notification to the first user device 204 indicating that the parking spot 304a may not be available for the first user 206 or that the second user 210 has declined the request to hold the parking spot 304a. In this case, the first user 206 may select any other potentially available parking spot from the potentially available parking spots 304.

On the other hand, when the second user 210 accepts the parking hold request, the processor 218 may reserve the parking spot 304a for the first user 206. In addition, the processor 218 may transmit, via the transceiver 216, a confirmation notification to the first user device 204 indicating that the second user 210 has accepted the parking hold request. In further aspects, the processor 218 may assist the first user 206 navigate the vehicle 202 to parking spot 304a location. Furthermore, the processor 218 may transmit, via the transceiver 216, a third command signal to the first user device 204 to switch the user interface 302 from displaying the parking location map to displaying the navigation map. The third command signal may include the navigation instructions to assist the first user 206 navigate the vehicle 202 to the parking spot 304a location. Responsive to viewing the navigation instructions or the navigation map on the user interface 302, the first user 206 may follow the instructions and reach to the parking spot 304a location.

The second user 210 may vacate the parking spot 304a when the first user 206 (or the vehicle 202) arrives at the parking spot 304a. In additional aspects, when the processor 218 determines that the vehicle 202 has arrived at the parking spot 304a and the second user 210 has vacated the parking spot 304a (as determined by real-time geolocations of vehicles 202, 106), the processor 218 may execute instructions stored in the payment module 232 and may transfer a predefined amount of resources (e.g., money) from a first user 206 account to a second user 210 account. In this case, the processor 218 may fetch first and second users' bank account details, credit card information, and/or the like, from the user information database 228 and cause money transfer from the first user 206 account (e.g., the bank account or an account associated with the first user 206 on the system 200) to the second user 210 account, using the instructions stored in the payment module 232.

In additional aspects, when the processor 218 determines that the vehicle 202 is parked at the parking spot 304a (by using the vehicle 202 real-time geolocation or first user device 204 location), the processor 218 may transmit, via the transceiver 216, a parking location leave time input request to the first user device 204. The parking location leave time input request may be a request for receiving an expected first user parking leave time for the parking spot 304a. Stated another way, the parking location leave time input request may be a request for receiving an expected time when the first user 206 may vacate the parking spot 304a.

Responsive to receiving the parking location leave time input request on the first user device 204, the first user 206 may input the expected parking leave time, and the transceiver 216 may receive the expected parking leave time via the network 212. The transceiver 216 may send the expected parking leave time to the parking information database 222 for storage purpose.

In further aspects, responsive to determining that the vehicle 202 is parked at the parking spot 304a, the processor 218 may fetch advertisement information associated with an area in proximity to the road network 104 from the advertisement information database 224. In some aspects, the advertisement information database 224 may pre-store advertisement information associated with one or more service providers that may be located in the area in proximity to the road network 104. For example, the advertisement information database 224 may pre-store advertisement information associated with car mechanics, pet stores, food trucks, restaurants, coffee shops, locksmiths, events, etc. that may be located in proximity to the road network 104.

Responsive to determining that the vehicle 202 is parked at the parking spot 304a, the processor 218 may fetch the advertisement information described above from the advertisement information database 224, and may transmit, via the transceiver 216, a fourth command signal to the first user device 204. The fourth command signal may include instructions to cause the user interface 302 to display the advertisement information. The fourth command signal may include the advertisement information, so that the first user device 204 may display the advertisement information when the first user device 204 receives the fourth command signal from the transceiver 216.

An example snapshot of a display screen displaying the advertisement information is shown in FIG. 4. Specifically, FIG. 4 depicts a second example snapshot 400 of a user interface 402 in accordance with the present disclosure. As depicted in the snapshot 400, the user interface 402 may display location information (or location icons) of one or more service providers 404a, 404b, 404c, 404n (or service providers 404) that may be located in road network 104 vicinity. The user interface 402 may further display an advertisement information “ticker” 406 that may include the advertisement information associated with the service providers 404.

Although the description above describes that the processor 218 determines that the vehicle 202 is parked at the parking spot 304a by using the vehicle 202 real-time geolocation (or the first user device 204 location), in some aspects, the processor 218 may determine vehicle 202 parking status by other means. For example, in one aspect, the processor 218 may transmit, via the transceiver 216, a parking confirmation request to the first user device 204. The parking confirmation request may be a request for the first user 206 to confirm whether vehicle 202 is parked. Responsive to receiving the parking confirmation request on the first user device 204, the first user 206 may send a confirmation to the processor 218 via the first user device 204 when the vehicle 202 is parked. In some aspects, the confirmation sent by the first user device 204 may further include geolocation of a parking spot where the vehicle 202 is parked (e.g., when the first user 206 parks the vehicle 202 at a parking spot different from the parking spot 304a).

In additional aspects, the processor 218 may determine the vehicle 202 parking status by tracking vehicle 202 movement (e.g., by tracking the vehicle 202 real-time geolocation) or first user device 204 movement (e.g., by tracking the first user device 204 location). In an exemplary aspect, the processor 218 may determine that the vehicle 202 may be parked when the vehicle 202 or the first user device 204 is stationary for a predefined time duration (e.g., more than two minutes). In this case, the processor 218 may transmit the parking confirmation request to the first user device 204, as described above. In a similar manner, the processor 218 may be configured to determine that the vehicle 202 may have left the parking spot (e.g., the parking spot 304a) by tracking the vehicle 202 movement.

In further aspects, the processor 218 may be configured to track real-time first user device 204 location or movement when or after the vehicle 202 is parked. For example, the processor 218 may track the first user device 204 location or movement by using location signals received from Global Positioning System (GPS) receiver (not shown) included in the first user device 204. In a scenario where the first user device 204 may be located in proximity to the vehicle 202 before the expected parking location leave time associated with the first user 206, the processor 218 may send a notification to the first user device 204 confirming if the first user 206 desires to vacate the parking spot 304a earlier than expected. The first user 206 may reply to the notification, indicating a new expected parking location leave time, or may indicate that the first user 206 does not desire to modify the expected parking location leave time.

In additional aspects, the processor 218 may be configured to determine malicious users who may be using the system 200, by tracking real-time geolocations of user devices associated with users. In an exemplary aspect, the processor 218 may determine a user to be a malicious user when the user device associated with the user may be frequently “away” from corresponding parked vehicle at expected parking location leave times. For example, if a user “A” is away from user's parked vehicle more than five times in a month at expected parking location leave times provided by the user “A”, the processor 218 may determine the user “A” to be a malicious user. In this case, the processor 218 may de-register the user “A” from the system 200.

In further aspects, the service provider database 226 may store information associated with one or more valet service providers (or a valet service provider). The valet service provider may provide valet service to system 200 users (e.g., the first and second users 206, 210) and the service provider database 226 may store information associated with one or more valet personnel associated with the valet service provider. For example, the service provider database 226 may store names, contact details, experience, social security numbers, geolocation, and/or the like, for each valet personnel.

In a scenario when the first user 206 may not be able to drive or navigate the vehicle 202 to the parking spot 304a, the first user 206 may request for valet service by transmitting a valet request to the system 200, via the first user device 204. The transceiver 216 may receive the valet request from the first user device 204, and may send the valet request to the processor 218. Responsive to receiving the valet request, the processor 218 may obtain valet personnel information from the service provider database 226 and may determine a list of “available” valet personnel in the road network 104 vicinity. For example, the processor 218 may determine those valet personnel who may be available when the first user 206 submits the valet request and who may be in proximity to the vehicle 202.

Responsive to determining the available valet personnel, the processor 218 may transmit, via the transceiver 216, the list of available valet personnel and associated information (e.g., names, contact details, experience, etc.) to the first user device 204. The first user 206 may select a valet personnel from the list, and the processor 218 may send a request including the vehicle 202 real-time geolocation to the valet personnel (specifically to a user device associated with the valet personnel). The valet personnel may then assist the first user 206 in parking the vehicle 202.

In some aspects, the valet personnel may drop vehicle 202 keys in a dedicated system 200 key repository in the road network 104 vicinity, when the valet personnel parks the vehicle 202. The first user 206 or another valet personnel may pick the vehicle 202 keys from the system 200 key repository when the first user 206 is ready to use the vehicle 202 (i.e., vacate the parking spot). The processor 218 may additionally transmit geolocation of the parking spot where the valet personnel may have parked the vehicle 202 to the first user device 204, so that the first user 206 may easily locate the vehicle 202.

Although the description above describes aspects where a public parking spot (e.g., the parking spot 304) is used by multiple users (e.g., the first and second users 206, 210), in additional aspects, a private parking spot owner may offer a private parking spot for rent on the system 200. In this case, the owner may provide information associated with the private parking spot to the system 200, and the system 200 may enable “parking spot search” feature on the system 200. The information may include, for example, private parking spot location, area, availability of Electric Vehicle (EV) charger, duration for which the private parking spot is available for rent, and/or the like. A user searching for the parking spot may use the system 200 to search for one or more private parking spots based on the provided information. In further aspects, the owner may accept “bids” for the private parking spot, and the user offering the maximum rent amount may be allocated the private parking spot by the system 200.

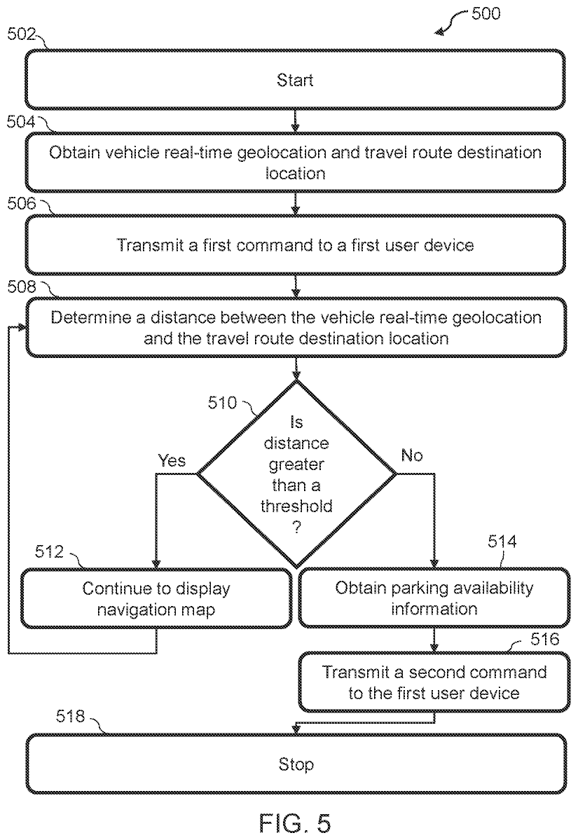

FIG. 5 depicts a flow diagram of an example parking assist method 500 in accordance with the present disclosure. FIG. 5 may be described with continued reference to prior figures, including FIGS. 1-4. The following process is exemplary and not confined to the steps described hereafter. Moreover, alternative embodiments may include more or less steps that are shown or described herein and may include these steps in a different order than the order described in the following example embodiments.

Referring to FIG. 5, at step 502, the method 500 may commence. At step 504, the method 500 may include obtaining, by the processor 218, the vehicle 202 real-time geolocation and travel route destination location associated with a travel route that the first user 206 may undertake. As described in conjunction with FIG. 2, the processor 218 may obtain the vehicle 202 real-time geolocation from the transceiver 216 and the destination location from the user information database 228.

At step 506, the method 500 may include transmitting, by the processor 218 (via the transceiver 216), a first command signal to the first user device 204. As described in conjunction with FIG. 2, the first command signal may include instructions to cause a first user device UI (or the vehicle 202 HMI) to display a navigation map that may assist the first user 206 navigate the vehicle 202 to the destination location. The first command signal may further include the navigation map, so that the first user device 204 (or the vehicle 202 HMI) may display the navigation map.

At step 508, the method 500 may include determining, by the processor 218, a distance between the vehicle 202 real-time geolocation and the destination location. At step 510, the method 500 may include determining, by the processor 218, whether the distance is greater than a threshold (e.g., 100 or 200 feet).

Responsive to determining that the distance is greater than the threshold, at step 512, the processor 218 may cause the first user device UI (or the vehicle 202 HMI) to continue displaying the navigation map. The method 500 may move back to the step 508 after the step 512.

On the other hand, if the processor 218 determines at the step 510 that the distance is less than the threshold, the method 500 may move to step 514. At step 514, the method 500 may include obtaining, by the processor 218, parking location availability information or map from the parking information database 222. At step 516, the method 500 may include transmitting, by the processor 218 (via the transceiver 216), a second command signal to the first user device 204. As described above, the second command signal may include instructions to cause the first user device UI (or the vehicle 202 HMI) to automatically switch display from the navigation map to the parking location map or parking location availability information. The second command signal may further include the parking location map or parking location availability information, so that the first user device 204 (or the vehicle 202 HMI) may display the parking location availability information/map.

At step 518, the method 500 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A parking assist system comprising:
a transceiver configured to receive a travel route destination location and a vehicle real-time geolocation;
a memory configured to store parking information comprising parking spot locations in a geographical area in proximity to the travel route destination location, and an occupancy status of each parking spot; and
a processor configured to:
obtain the vehicle real-time geolocation and the travel route destination location from the transceiver;
transmit a first command signal to a first user interface to display a navigation map responsive to obtaining the vehicle real-time geolocation and the travel route destination location;
determine whether a distance between the vehicle real-time geolocation and the travel route destination location is less than a predefined threshold;
obtain the parking information from the memory based on a determination that the distance is less than the predefined threshold; and
transmit a second command signal to the first user interface to switch display from the navigation map to a parking location map responsive to obtaining the parking information, wherein the parking location map comprises the occupancy status.

2. The parking assist system of claim 1, wherein the first command signal comprises the navigation map.

3. The parking assist system of claim 1, wherein the second command signal comprises the parking location map.

4. The parking assist system of claim 1, wherein the transceiver is further configured to receive an expected parking leave time from a second user interface, and wherein the expected parking leave time is associated with a first vehicle parked at a first parking spot in the geographical area.

5. The parking assist system of claim 4, wherein the memory is further configured to store the expected parking leave time in the parking information.

6. The parking assist system of claim 4, wherein the transceiver is further configured to receive a selection of the first parking spot from the first user interface responsive to displaying the parking location map.

7. The parking assist system of claim 6, wherein the processor is further configured to:
obtain the selection of the first parking spot from the transceiver;
transmit a confirmation request to the second user interface associated with the first parking spot;
obtain a confirmation response from the second user interface in response to transmitting the confirmation request; and
reserve the first parking spot for a user associated with the first user interface based on the confirmation response.

8. The parking assist system of claim 7, wherein the processor is further configured to transmit navigation instructions to the first user interface to navigate a second vehicle to the first parking spot.

9. The parking assist system of claim 8, wherein the processor is further configured to:
determine whether the second vehicle is parked;
transmit a parking location leave time input request to the first user interface based on the determination;
obtain an expected first user parking leave time from the first user interface responsive to the transmission of the parking location leave time input request; and
transmit the expected first user parking leave time to the memory for storage.

10. The parking assist system of claim 9, wherein the processor determines that the second vehicle is parked when the vehicle real-time geolocation is same as a first parking spot location, or when the second vehicle is stationary for a predefined time duration.

11. The parking assist system of claim 9, wherein the memory is further configured to store advertisement information associated with the geographical area.

12. The parking assist system of claim 11, wherein the processor is further configured to:
obtain the advertisement information when the processor determines that the second vehicle is parked; and
transmit a third command signal to the first user interface to display the advertisement information on the first user interface responsive to obtaining the advertisement information.

13. A parking assist method comprising:
obtaining, by a processor, a vehicle real-time geolocation and a travel route destination location from a transceiver;
transmitting, by the processor, a first command signal to a first user interface to display a navigation map responsive to obtaining the vehicle real-time geolocation and the travel route destination location;
determining, by the processor, whether a distance between the vehicle real-time geolocation and the travel route destination location is less than a predefined threshold;
obtaining, by the processor, parking information from a memory based on a determination that the distance is less than the predefined threshold, wherein the memory is configured to store the parking information comprising parking spot locations in a geographical area in proximity to the travel route destination location, and an occupancy status of each parking spot; and
transmitting, by the processor, a second command signal to the first user interface to switch display from the navigation map to a parking location map responsive to obtaining the parking information, wherein the parking location map comprises the occupancy status.

14. The parking assist method of claim 13, wherein the first command signal comprises the navigation map.

15. The parking assist method of claim 13, wherein the second command signal comprises parking location map.

16. The parking assist method of claim 13 further comprising obtaining an expected parking leave time from a second user interface, and wherein the expected parking leave time is associated with a first vehicle parked at a first parking spot in the geographical area.

17. The parking assist method of claim 16 further comprising:
obtaining a selection of the first parking spot from the first user interface responsive to displaying the parking location map;
transmitting a confirmation request to the second user interface associated with the first parking spot;
obtaining a confirmation response from the second user interface in response to transmitting the confirmation request; and
reserving the first parking spot for a user associated with the first user interface based on the confirmation response.

18. The parking assist method of claim 17 further comprising transmitting navigation instructions to the first user interface to navigate a second vehicle to the first parking spot.

19. The parking assist method of claim 18 further comprising:
determining whether the second vehicle is parked;
transmitting a parking location leave time input request to the first user interface based on the determination;
obtaining an expected first user parking leave time from the first user interface responsive to the transmission of the parking location leave time input request; and
transmitting the expected first user parking leave time to the memory for storage.

20. A non-transitory computer-readable storage medium in a distributed computing system, the non-transitory computer-readable storage medium having instructions stored thereupon which, when executed by a processor, cause the processor to:
obtain a vehicle real-time geolocation and a travel route destination location from a transceiver;
transmit a first command signal to a first user interface to display a navigation map responsive to obtaining the vehicle real-time geolocation and the travel route destination location;
determine whether a distance between the vehicle real-time geolocation and the travel route destination location is less than a predefined threshold;
obtain parking information from a memory based on a determination that the distance is less than the predefined threshold, wherein the memory is configured to store the parking information comprising parking spot locations in a geographical area in proximity to the travel route destination location, and an occupancy status of each parking spot; and
transmit a second command signal to the first user interface to switch display from the navigation map to a parking location map responsive to obtaining the parking information, wherein the parking location map comprises the occupancy status.
